(19) United States
(12) Patent Application Publication
(10) Pub. No.: US 2024/0012834 A1
(43) Pub. Date: Jan. 11, 2024

(54) DATA SYNCHRONIZATION ACROSS IMMUTABLE AND MUTABLE DATA STORAGE SYSTEMS

(71) Applicant: PlayStudios US, LLC, Belmont, CA (US)

(72) Inventors: Heinrich Fidencio Terborg, Mexico City (MX); Moises Rodrigo Santiago Garcia, Mexico City (MX); Israel Ramos Dominguez, San Francisco del Rincon Guanajuato (MX); Shih-Chien Lee, Belmot, CA (US)

(21) Appl. No.: 18/216,570

(22) Filed: Jun. 29, 2023

Related U.S. Application Data
(60) Provisional application No. 63/358,487, filed on Jul. 5, 2022.

(51) Int. Cl. G06F 16/27; G06F 16/23; G06F 11/34

(52) U.S. Cl. CPC G06F 16/27; G06F 16/2365; G06F 11/3419

(57) ABSTRACT

A method and/or a system for synchronizing data across immutable and mutable data storage systems. The system provides an endpoint configured to receive messages associated with database actions from client devices. Responsive to receiving a message associated with a database action via the endpoint, the system routes the message to an action queue. The system transmits the message from the action queue to multiple data engines corresponding to multiple data storage systems that store data, causing the multiple data engines to perform the action based on the message. The multiple data engines include a mutable data engine corresponding to a mutable data storage system and an immutable data engine corresponding to an immutable data storage system. The system tracks the action queue to determine an action performance speed of each data engine.

### CROSS-REFERENCE TO RELATED APPLICATIONS

This application claims priority to U.S. Provisional Patent Application Ser. No. 63/358,487, titled “High Efficiency Method to Update and Synchronize Data from A Plurality of Immutable and Mutable Data Storage Systems,” filed Jul. 5, 2022, which is incorporated herein by reference in its entirety.

### TECHNICAL FIELD

The present disclosure relates to data synchronization across multiple data storage systems, specifically to data synchronization across immutable and mutable data storage systems.

### BACKGROUND

Decentralized web (also referred to as Web 3), represents the next phase in the evolution of the Internet. It is an emerging paradigm that aims to decentralize online platforms and services, fostering greater user control, privacy, and security. Unlike its predecessor, Web 2.0, which is predominantly centralized and relies on intermediaries, Web3 is characterized by decentralized platforms, blockchain technology, and enhanced user control. It aims to create a more transparent, secure, and user-centric online ecosystem by leveraging concepts such as cryptocurrencies, smart contracts, decentralized applications (dApps), decentralized finance (DeFi), and decentralized identity (DID) solutions. Web3 strives to remove the reliance on intermediaries, promote peer-to-peer interactions, and empower individuals with greater privacy, security, and ownership of their data and digital assets.

The concept of decentralization may be achieved through distributed ledger technology, e.g., blockchain and smart contracts. Blockchain allows for transparent and immutable record-keeping, ensuring trust and eliminating the need for a central authority. Smart contracts, on the other hand, are self-executing contracts with predefined rules encoded on the blockchain, enabling automated and secure transactions.

While decentralized systems or blockchain technologies offer many advantages, they also have some limitations. For example, blockchain database systems face challenges in handling large volumes of transactions and scaling to meet the demands of a rapidly growing user base, while centralized databases can typically handle higher transactions more efficiently. Further, due to the distributed nature of blockchains, transaction processing can be slower in blockchains compared to centralized databases. The consensus mechanisms and cryptographic computations involved in validating transactions can introduce delays.

### SUMMARY

Embodiments described herein include a system and a method for data synchronization across multiple immutable and mutable data storage systems. For example, a system provides an endpoint configured to receive messages associated with database actions (e.g., POST actions, GET actions, DELETE actions, PATCH actions, etc.) from client devices. Responsive to receiving a message associated with a database action via the endpoint, the system routes the message to an action queue. In some embodiments, the message is routed to one of a plurality of action queues based in part on a set of rules.

The system transmits the message from the action queue to a plurality of data engines corresponding to a plurality of data storage systems that store data, causing the plurality of data engines to perform the database action based on the message. The plurality of data engines includes a mutable data engine corresponding to a mutable data storage system (e.g., a centralized database) and an immutable data engine corresponding to an immutable data storage system (e.g., a blockchain, a distributed ledger, or decentralized database). In some embodiments, the mutable data engine corresponds to at least one of an in-memory database, a relational database, a NoSQL database, and/or a timeseries database. In some embodiments, the immutable data engine corresponds to a blockchain or a distributed ledger. The system also tracks the action queue to determine an action performance speed of each of the plurality of data engines.

In some embodiments, the message comprises a request to achieve a specific level of consensus among the plurality of data engines. In some embodiments, the specific level of consensus may include a minimum number of data engines to return a same confirmation responsive to performing the action. In some embodiments, the specific level of consensus may include a minimum number and/or a mixture of immutable and mutable data engines to return a same confirmation responsive to performing the action.

Other aspects include components, devices, systems, improvements, methods, processes, applications, computer readable mediums having program code encoded thereon, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an embodiment of a data distribution system in accordance with some embodiments.

FIG. 2 illustrates an example process of tracking queues in accordance with one or more embodiments.

FIG. 3A illustrates an example embodiment of a writing procedure in accordance with some embodiments.

FIG. 3B illustrates an example process of writing to an immutable database in accordance with some embodiments.

FIG. 3C illustrates an example process of writing to a mutable database in accordance with some embodiments.

FIGS. 4A-4B illustrate an example process of performing a reading procedure.

FIG. 5A illustrates an example architecture of a data broker (corresponding to the data distribution platform) in accordance with some embodiments.

FIG. 5B illustrates another example architecture of a data broker in accordance with some embodiments.

FIG. 5C illustrates another example architecture of a data broker in accordance with some embodiments.

FIG. 6A illustrates an example architecture of a mutable database in accordance with some embodiments.

FIG. 6B illustrates another example architecture of a mutable database in accordance with some embodiments.

FIG. 6C illustrates another example architecture of a mutable database in accordance with some embodiments.

FIG. 7 illustrates an example graphical user interface that allows users to create a message broker in accordance with some embodiments.

FIG. 8 illustrates another example graphical user interface that allows users to choose a single-instance broker mode or a cluster broker mode in accordance with some embodiments.

FIG. 9 illustrates an example graphical user interface that allows users to choose a broker instance type in accordance with some embodiments.

FIG. 10 illustrates an example user interface that shows a broker status as running in accordance with some embodiments.

FIG. 11 illustrates an example user interface that shows information associated with a particular broker in accordance with some embodiments.

FIG. 12 illustrates an example process of remote procedure call (RPC) in accordance with some embodiments.

FIGS. 13A-13C illustrate an example process of lazy minting in a data distribution system in accordance with some embodiments.

FIG. 14 illustrates another example process of lazy minting in accordance with some embodiments.

FIG. 15 illustrates another example process of lazy minting in accordance with some embodiments.

FIG. 16 illustrates an example machine of a computer system in accordance with some embodiments.

### DETAILED DESCRIPTION

Embodiments described herein relate to a data distribution system or method configured to update and synchronize data across multiple immutable and mutable data storage systems. The data distribution system ensures synchronization and resilience among a diverse range of immutable and mutable storage systems, each with varying transaction per second (TPS) capabilities. By keeping all systems in sync, the platform guarantees the ability to respond with the latest state, irrespective of the status of any particular system. This approach enhances resilience by mitigating failures of individual systems and enables consistent access to up-to-date data.

Web3, also known as the decentralized web, represents the next phase in the evolution of the Internet. It is an emerging paradigm that aims to decentralize online platforms and services, fostering greater user control, privacy, and security. Unlike its predecessor, Web2, which is predominantly centralized and relies on intermediaries, Web3 seeks to empower individuals by enabling peer-to-peer interactions and removing the need for intermediaries.

While decentralized systems or blockchain technologies offer many advantages, they also have some limitations. For example, blockchain database systems face challenges in handling large volumes of transactions and scaling to meet the demands of a rapidly growing user base, while centralized databases can typically handle higher transaction throughout more efficiently. Further, due to the distributed nature of blockchains, and the consensus mechanisms and cryptographic computations involved in validation, transaction processing can be slower compared to centralized databases.

With the shift towards web3, there is a growing need for online systems to exhibit high scalability, measured by their ability to handle a significant number of transactions per second (TPS). There is often a trade-off between opting for larger, existing immutable systems and smaller, but faster ones, which may lead to compatibility issues and potential customer loss in the process.

The principles described herein solve the above-described problem by providing a data distribution system or method that enables updating and synchronizing data from multiple immutable and mutable data storage systems.

The data distribution system (hereinafter also referred to as the “system” or “data broker”) provides a variety of storage systems with different TPS capabilities. The data distribution system is configured to keep the variety of storage systems in sync, such that it is resilient among failures of individual systems and able to respond with the last state regardless of states of individual systems.

In some embodiments, the system includes a message broker, one or more database prosumer blocks, and one or more data engines, each of which corresponds to a mutable or an immutable database. A data prosumer is a component that both produces and consumes data. In some embodiments, the databases (corresponding to the data engines) include at least one in memory database configured to store current state, at least one NoSQL or timeseries database, and at least one immutable data storage. The database prosumer blocks include pieces of middleware that keep track of each engine's limitations and current state, such as current amount of TPS for a particular operation, current state, and transactions behind the current state. The message broker is configured to redirect requests to all the required database prosumer blocks, which keeps every data engine in sync.

In some embodiments, summarizing and/or compression techniques are also implemented to avoid lagging responsive to TPS exceeding a predefined number. In some embodiments, when a greater level of confidence is required, the system seeks and waits for consensus among several data engines.

In some embodiments, when a collection of tokens, e.g., non-fungible tokens (NFTs) or fungible tokens, is approved to be lazy minted, the system calls a mutable data engine only, causing the mutable data engine to mint the collection of tokens in a virtual wallet corresponding to a real wallet on blockchain. Responsive to receiving a call to retrieve contents in the real wallet, the system calls a read function to read contents in the real wallet. The system also calls the mutable database to see if a virtual wallet corresponding to the real wallet exists. If the virtual wallet exits, the contents in the virtual wallet are returned, but metadata is marked to show that the tokens in the virtual wallet are not really minted, but virtually minted. The contents from the real wallet and the virtual wallet are joined and returned. The system presents the contents to the user, indicating whether particular tokens are really minted on the blockchain or virtually minted by a mutable data engine.

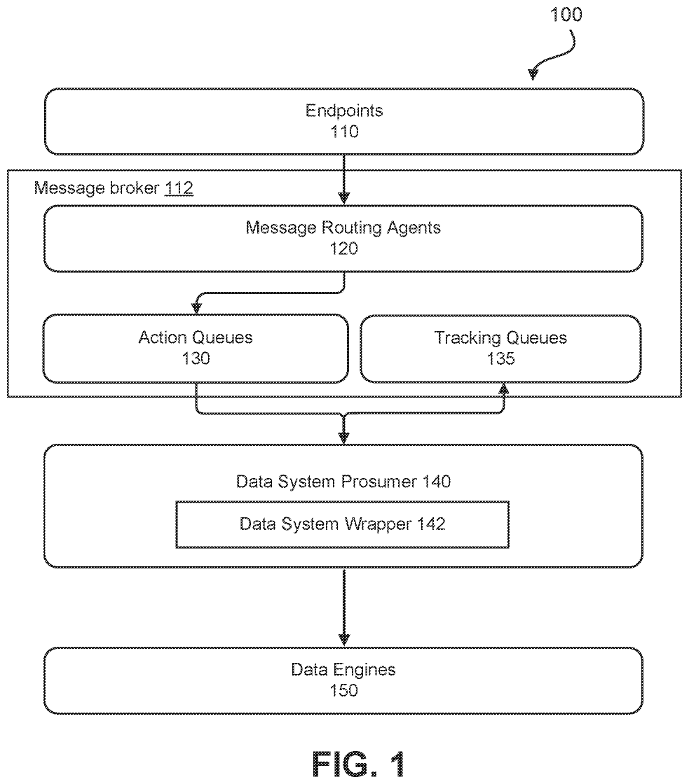

FIG. 1 illustrates an embodiment of a data distribution system 100 in accordance with some embodiments. The data distribution system 100 includes a set of endpoints 110, a message broker 112, a data prosumer 140, and a set of data engines 150. A data prosumer 140 is a component that both produces and consumes data. The message broker 112 includes a set of message routing agents 120, a set of action queues 130, and a set of tracking queues 135. The set of routing agents 120 are configured to automatically distribute a specific message received from the endpoints 110 via the application of a predefined set of rules to its proper destination, e.g., a specific database system or a subset of data systems. The set of tracking queues 135 is configured to act as placeholders for the requested actions on specific data systems. The actions stay in a queue, which will also keep record of their order of arrival (e.g., first in first out) until these are consumed by one or more data prosumers 140. The tracking queues 135 keep track of the latest actions executed on a specific data storage system. These queues hold key information enabling the system to know the TPS and the updated status of individual databases.

In some embodiments, the database prosumers 140 include one or more data system wrappers 142 that extract content from messages in the action queue and transform it into a different form. In some embodiments, the data system wrappers 142 include software interfaces capable of communicating with the action queues 135 and provide direct connections with specific data engines 150 (which may be mutable or immutable). The data engines 150 correspond to underlying data storage systems configured to store the data. The data storage systems corresponding to the data engines 150 may include (but are not limited to) a relational database, a NoSQL database, an in-memory database, a timeseries database, a public blockchain, a private blockchain, etc. The data engines 150 may have varying TPSs. Typically, an immutable database has a lower TPS than a mutable database.

In some embodiments, the data engines 150 are ranked for their trustworthiness scores, as such if any discrepancy happens inside the system, the action recorded in a higher ranked data engine controls. For example, if a first data engine with a first rank has recorded an action that is not present in a second data engine with a second rank that is higher than the first rank, the first data engine will subordinate itself to the second data engine.

Tracking queues 135 are used to get updates on the last action carried out by each one of the database prosumers. Tasks carried out by tracking queues 135 include keeping track of updates to the database, measuring the current TPS, and/or keeping track of how far behind this specific data engine. In some embodiments keeping track of how far behind a specific database is from the most up-to-date data engine (e.g., the one with a higher value for last state ID).

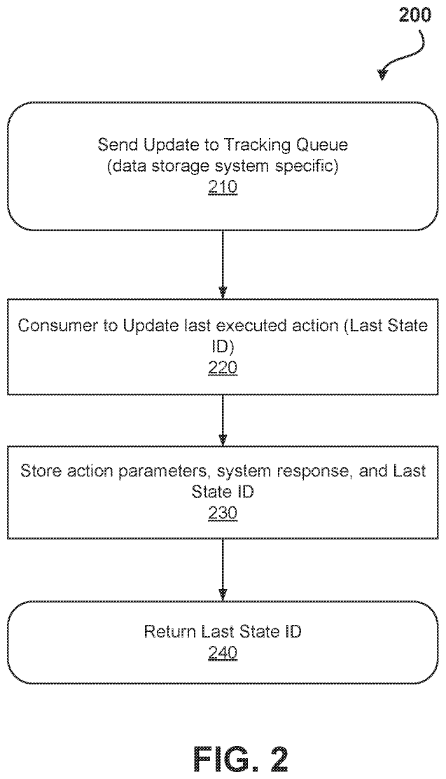

FIG. 2 illustrates an example process of tracking queues, in accordance with one or more embodiments. The system sends 210 an update to a tracking queue. This update includes data from an action performed against the data engine and the response. The system listens to this message queue. In some embodiments, the module that listens to this message queue is a consumer. The consumer updates 220 a last state ID for the data engine to which this tracking queue belongs. In some embodiments, the last state ID is an incremental number. In some embodiments, this value is then stored so that it is available to other parts of the system that requires it. In some embodiments, the consumer also constantly calculates the TPS that the specific data engine was able to handle during a predefined period of time. This information is then stored 230 and the last state ID is returned 240.

In some embodiments, each database prosumer in the system, whether mutable or immutable, is ranked given its importance to the end application of the system. When a discrepancy arises among different engines, it is solved by enforcing the highest-ranking database towards the lower ranking one.

### Writing Procedure

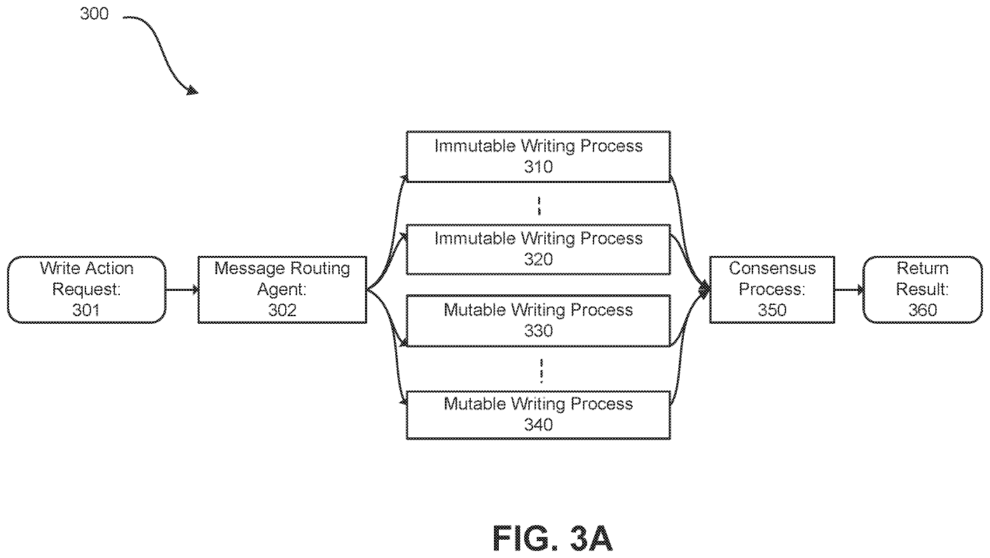

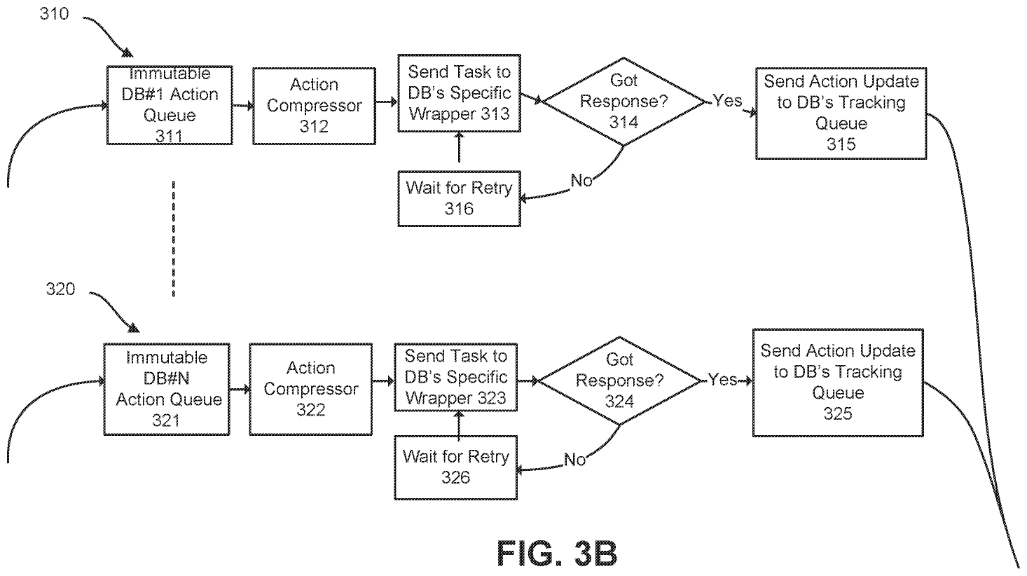

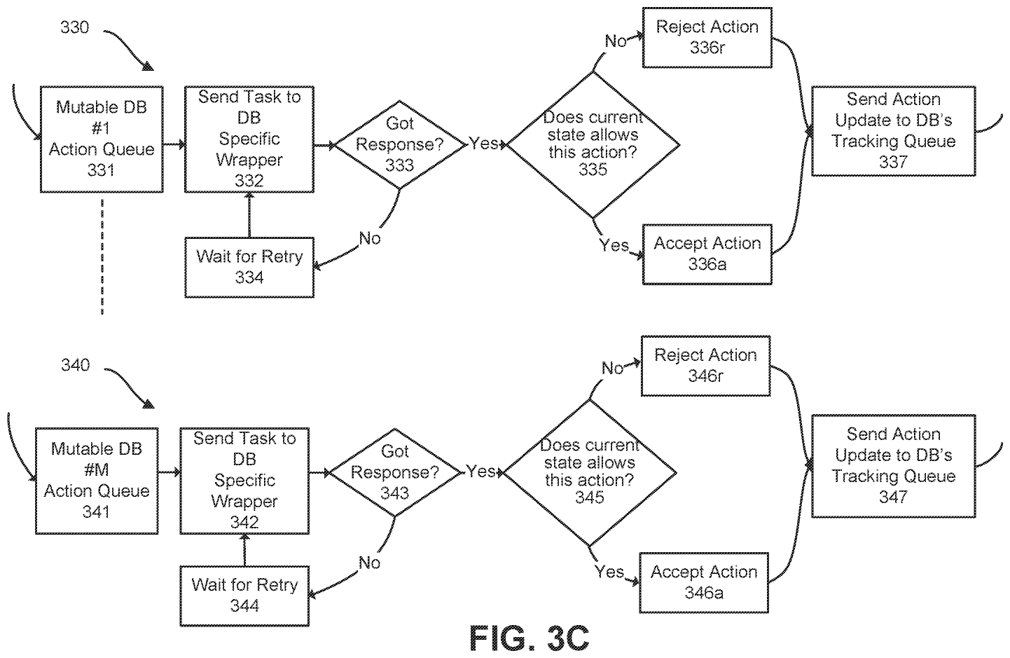

FIG. 3A illustrates an example embodiment of a writing procedure 300 in accordance with some embodiments. When a request to write to the system 301 is received, an action message 302 is generated and passed through the message routing agent. In some embodiments, the action message 302 also includes information regarding an amount of consensus that should be achieved among the data engines (e.g., a minimum number of data engines) in the system before the action if considered as correctly executed. For instance, the system may be requested to have confirmations from at least two mutable databases and at least one immutable database, or even which specific data engine should have executed the action before returning a result. As illustrated, immutable writing process 310 is performed by a first immutable database, immutable writing process 320 is performed by a second immutable database, mutable writing process 330 is performed by a first mutable database, and mutable writing process 340 is performed by a second mutable database. There may be additional immutable writing processes and/or mutable writing processes performed by additional immutable database and/or mutable databases. After the multiple writing processes 310-340 are completed, the system performs a consensus process 350 to determine whether the amount of consensus included in the action message 302 is achieved, and returns 360 the result.

FIG. 3B illustrates an example process 310, 320 of writing to an immutable database in accordance with some embodiments. The process starts with the reception of the action in a queue 311. From there, the action can first be parsed by an action compressor 312. The action compressor compresses several actions into one single action in order to virtually increase the TPS when the data engine has a TPS below a threshold TPS. The action is passed over to the data engine's specific wrapper 313. After the wrapper has passed the action to its corresponding data engine, the system verifies if it got the right response 314. If the underlying engine is not responding (for instance, due to down time or congestion), the system will wait a predefined amount of time 316 before sending the action again. After a response is received, a message is sent to the database's tracking queue 315 to update it with a positive confirmation that the action has been carried out.

In some embodiments, there may be more than one immutable database, each with different capabilities regarding TPS and uptime availability. In FIG. 3B, a second immutable database performs steps 321 to 326 which are equivalent steps to those described from 210 to 315. In some embodiments, a data engine may have low TPS capabilities. In such a case, action compressors 312, 322 may have actions compressed in order to end up at a single final state which has the same result but with fewer actions.

In some embodiments, there are several compressor and/or summarizer mechanisms depending on the pressure the system has to virtually increase the TPS for a specific prosumer to keep up with requests. A type of mechanism to use depends on whether only the final state is relevant, or also the information on how the final state was achieved (e.g., the path) is relevant too.

In some embodiments, lossless summary is performed in case the path is irrelevant. Lossless summary includes summarizing actions by writing only the final state. For example, the system aggregates transactions regarding several transfers to the same place into just one signal transfer for the full amount. If a digital item is moved among several digital addresses without other actions, the system moves directly to the final destination.

In some embodiments, lossy compression is performed in case the path or the time between events is relevant. Lossy compression includes summarizing actions to keep up with a higher requirement of TPS, and the final state can still be used as the main action to be recorded. In some embodiments, lossy compression may require inclusion of a digitally signed data addendum including the path and time between events.

FIG. 3C illustrates an example process 330, 340 of writing to a mutable database in accordance with some embodiments. Writing to a mutable database starts with the reception of the action message in Queue 331. Usually, mutable databases have a high enough TPS to handle requests from the loyalty platform in real-time, so that the action compressor is optional or not needed at all. The action is sent to the data engine's specific wrapper 332 and the system will wait for a response 333. If the database is not responding, the system will wait for a predefined amount of time before retrying 334. Unlike immutable data engine, which often able to enforce a certain set of rules on the actions that can be performed or not, rules of a mutable data engine are enforced externally 335. The external rule enforcing process 335 often take place in order to avoid future discrepancies between mutable and immutable databases. In case the action is rejected by enforcement 335, a reason may be stated. Therefore, the mutable database is emulating the functionality of an immutable one, because a rejection 336r will also imply that the same action is going to be rejected by an immutable database in the system when it gets to process that action. After a response, accepted 336a or rejected 336r, has been received, a message is sent to the data engine's tracking queue 337 to update it with a confirmation that the action has been carried out, and its result.

In some embodiments, several mutable databases can coexist, each with different features regarding TPS and uptime availability. For example, another mutable process is shown in steps 341 to 347, equivalent or similar to those from 331 to 337.

### Reading Procedure

Reading can happen with or without requiring consensus. When consensus is required, the system may expect a confirmation from an immutable database up to a certain state ID, which corresponds to a time when a specific action took place, but not necessarily the very last state ID. For instance, if confirmation is expected from an immutable database for a specific operation that took place in the past, the system may need to wait until said immutable database has arrived at that state where the changes in question are observed regardless of the very last known state.

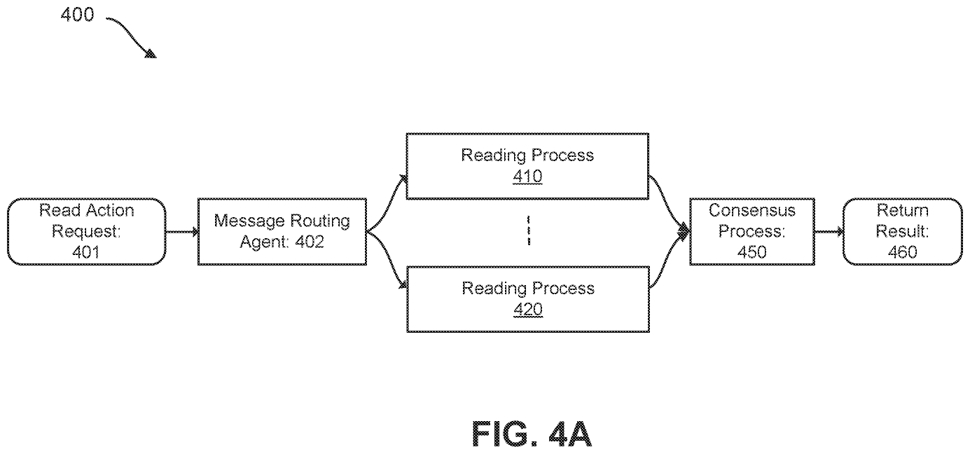

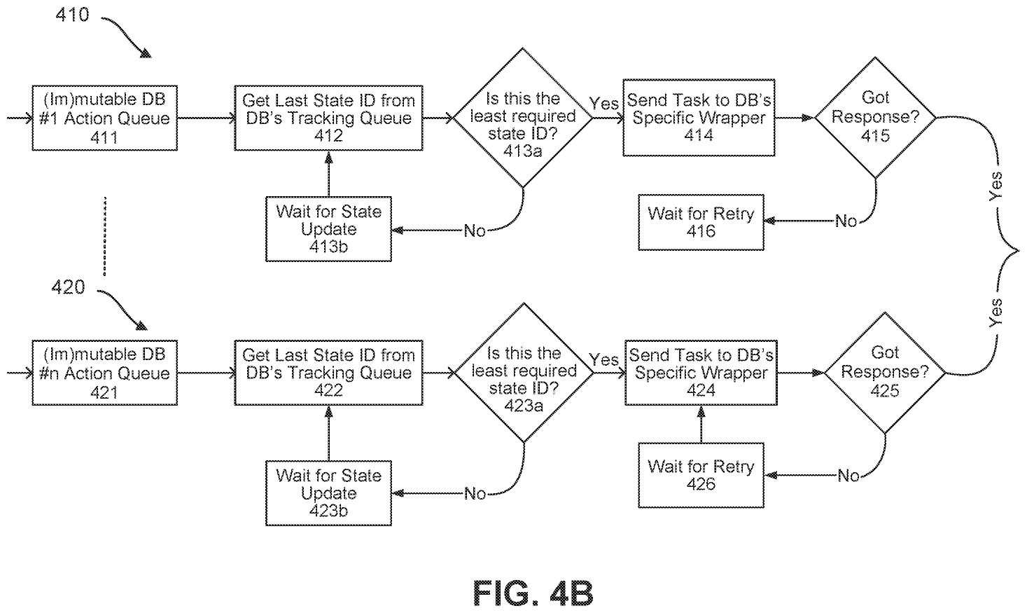

FIG. 4A illustrates an example process of performing a reading procedure 400 in accordance with some embodiments. When a read request 401 is received, a message is passed to the message routing agent 402, which may include the requested amount of consensus to be achieved (at a specific state ID). In some embodiments, a particular read action 401 can request to achieve a specific amount of consensus among a mixture of immutable and mutable databases to be achieved before returning the results of said action. In some embodiments, the system just waits to get the same response from all systems from which consensus is required before returning an answer. This often means waiting for immutable databases to catch up with the latest state ID.

Given the degree of consensus necessary, the message routing agent 402 may pass the request over to a specific set of mutable and immutable databases to fulfill the request. The particular reading process may be the same when the database is mutable or immutable. As illustrated, reading process 410 is performed by a first database (which may be mutable or immutable), and reading process 420 is performed by a second database (which may be mutable or immutable).

FIG. 4B illustrates a flowchart of an example reading process 410, 420 in accordance with some embodiments of the present disclosure. After the message is received in the specific action queue 411, the system requests 412 the last state ID required for this specific database. In the case the last state ID is not as updated as needed 413a, the system will wait for this database to update its state 413b. The waiting time can be estimated using the known TPS for this database prosumer and the number of pending actions in its queue, if the waiting tie exceeds a certain amount of time, the system will return with an error because the consensus will not be fulfilled on time.

In case the database has arrived at the desired state, the specific reading task is sent to the wrapper 414, which will retry 416 until it gets a response 415 and the result is sent to the consensus process 450. The same process is repeated for any other data engines requested by the read action, e.g., 421 to 425. After enough responses 415, 425 have been gathered to fulfill the request, the consensus process 450 is started.

The consensus process 450 takes all the answers from individual databases and matches these answers among each other seeking for inconsistencies. In case an inconsistency is found, the consensus mechanism will seek to solve it against a higher-ranking database. When only the latest known state is required without any consensus, the system will just return the result from database with the latest status ID.

Traditionally, a consumer is an automatic process or a job scheduler (e.g., CRON) that is constantly listening for a specific queue. In some cloud platforms, creation of a traditional automatic process is expensive due to a number of requests it generates. Unlike traditional approach, the embodiments described herein uses a message queue manager, which works in a similar way and costs much less than a traditional automatic process. Additionally, the message queue manager also does not have to wait to read the received messages.

In some cases, a query speed of a message queue manager may exceed one second because the memory was insufficient, and a timeout would occur for the request. To solve this problem, configuration of a consuming serverless compute service may be modified by increasing the memory and timeout to significantly decrease the processing time for each transaction.

In some embodiments, multiple events are allocated in a single serverless service and allow the single serverless service to be connected to multiple queues. The serverless service is configured to dynamically retrieve information received from each queue and process the retrieved information.

In some embodiments, the system is able to generate parallel processing with multiple queues. In some embodiments, all requests received in a single queue are to be processed sequentially, which may result in a delay in processing. In some embodiments, one queue per method (e.g., POST, GET, PATCH, DELETE) per module (user, fungibles, non-fungibles, marketplace) is created and implemented to receive transactions in parallel and void waiting times.

In some embodiments, multiple actions are integrated into a single action to speed up processing in a database that has a lower performance speed. It is detected that for the mining and transfer of consumables, transactions can be compressed (e.g., adding up the amounts for a same user), such that processing speed can be improved.

In some embodiments, the system described herein is configured to provide an answer in less than a second without relying on a blockchain. The processing times in blockchain are often high. The principles described herein implement a mutable database that simulates the functionality of a blockchain, yet provides an instant response. At the same time, the mutable database sends the request in the background to the blockchain without waiting for a result from the blockchain.

In some embodiments, transactions are executed in a main database, which generates a unique identifier for each transaction. The transactions are replicated in a secondary database, which is a blockchain. The blockchain generates an identifier that is related to the identifier of the primary database. This allows the primary database and secondary database to be in sync and the processing in the secondary database may be executed in the background.

Multiple development environments, including blockchains, centralized databases, and a message queue manager are configured to be interconnected to provide the system described herein.

Transaction tracking queues are generated to identify a number of transactions executed in each database. Lazy minting may be used to modify the transaction tracking. A consensus module may be implemented with a register of unique identifiers registered by the databases.

The system described herein also prevents transactions from executing in an incorrect order with multiprocessing in blockchain. A retry system of up to a maximum number of times may be implemented for when a transaction is to be executed. The maximum number may also be determined based on if an error is identified, and a retry is due to the detected error.

In some embodiments, multiprocessing is implemented at blockchain, similarly as in the primary database, to avoid accumulating transactions. The multiprocessing takes into account a waiting time for when a transaction is to be executed, depending on another transaction that has not yet been executed, or whether there is an error or try again for the other transaction.

In some embodiments, the system described herein removes a message from a queue until it has already been processed to avoid loss of information. In some embodiments, messages or transactions are processed from the replication queues by consumers. In case there is an error, a retry up to a maximum number may be performed. If there is still an error, the message may be removed from the queue and sent to a collection to be reviewed later. If there is no response from the endpoint to which the request is sent, the message is saved and sent until a response is received.

The principles described herein provide a data distribution platform that allow entities to create their own data distribution system based on needs of their own applications.

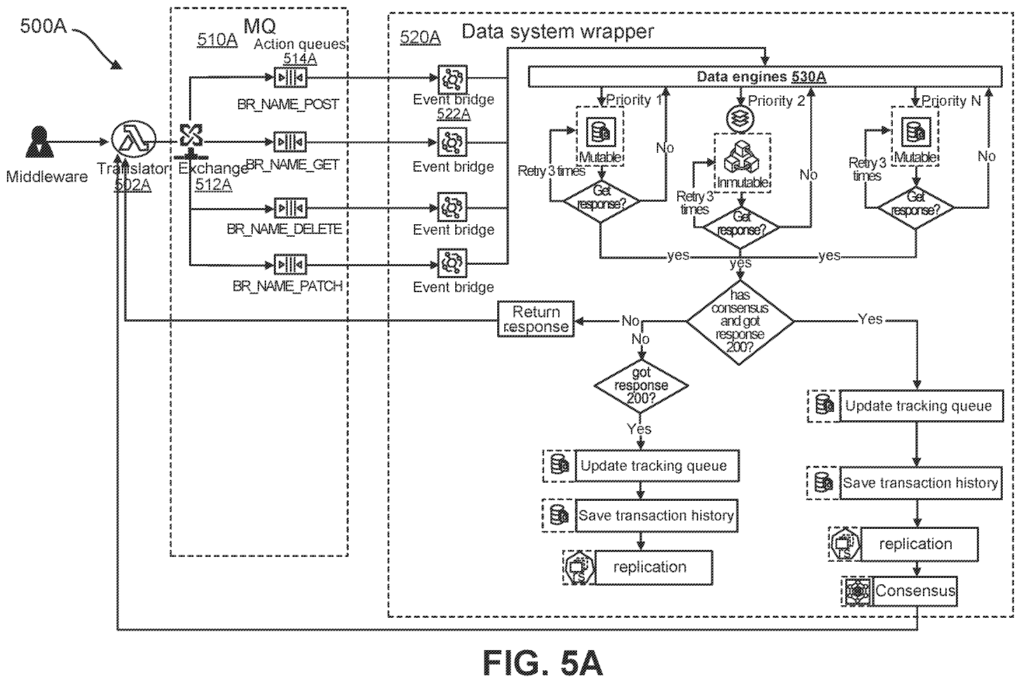

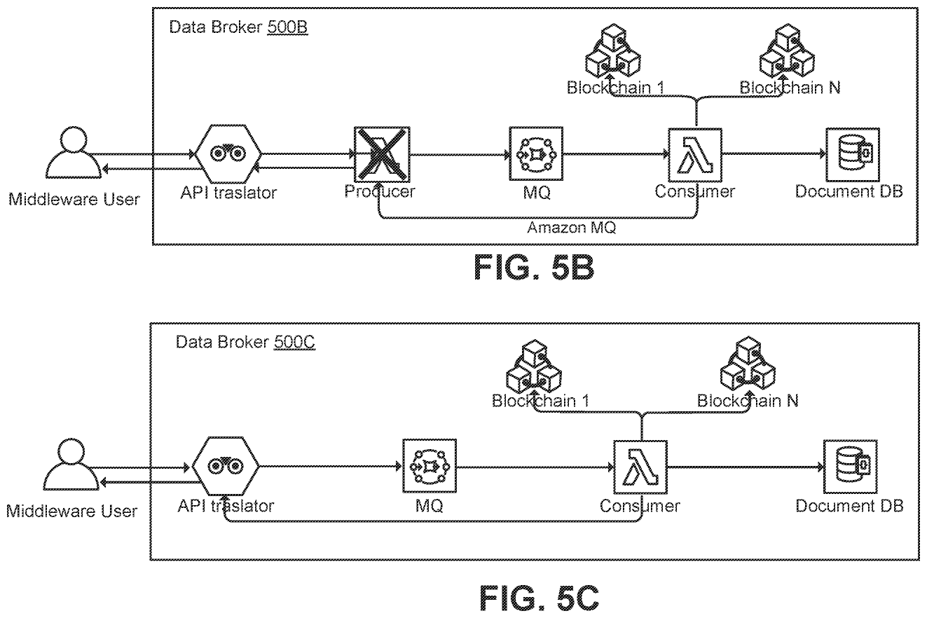

FIG. 5A illustrates an example architecture of a data broker 500A (corresponding to the data distribution platform) in accordance with some embodiments. The broker 500 includes a managed message broker service 510A (also referred to as MQ) that allows software applications and components to communicate with each other using various programming languages, operating systems, and formal messaging protocols. The managed message broker service 510A includes an exchange module 512A configured to receive messages. The managed message broker service 510A also has a plurality of action queues 514A, including (but not limited to) a POST action queue, a GET action queue, a DELETE action queue, and a PATCH action queue. The POST action queue stores messages associated with POST actions, the GET action queue stores messages associated with GET actions, the DELETE action queue stores messages associated with DELETE actions, and the PATCH action queue stores actions associated with PATCH actions.

As illustrated, the data broker 500A also includes a data system wrapper 520A, which corresponds to data system wrapper 142 of FIG. 1. In some embodiments, the data system wrapper 520A may be a serverless compute service. The data system wrapper 520A includes a plurality of event bridges 522A, each corresponding to an action queue 514A. Each event bridge 522A ingests data from its corresponding action queue to a plurality of data engines 530A. In some embodiments, the plurality of data engines 530A are ranked based on their priorities. In some embodiments, the priorities of the data engines 530A are determined based in part on their trustworthiness. Alternatively, or in addition, the priorities of the data engines are determined based in part on their TPSs. The plurality of data engines 530A includes one or more mutable databases and one or more immutable databases. When an action is passed on a data engine 530A (mutable or immutable), the data engine 530A tries to perform the action. If an attempt fails, the data engine 530A waits for a predetermined time to retry again. When a maximum number of attempts is reached, a particular data engine 530A still could not obtain a response or confirmation, the particular data engine 530A returns a negative result to the plurality of data engines 530A (which include other data engines 530A).

When a response or confirmation is obtained from one or more data engines 530A, the responses from different data engines 530A are compared to determine whether there is consensus. It also matters whether the response includes an OK status code (e.g., 200 status code) indicating that the request was successful, although the meaning of success depends on the request method used. For example, if it is a GET request, 200 status code means that the requested resource has been fetched and transmitted to the message body. If it is a POST request, 200 status code means that a description of the result of the action is transmitted to the message body. When there is no consensus and no 200 status code, a negative result is returned to a translator 502. When there is no consensus, but 200 status code, a tracking queue is updated, transaction history is saved, and replication is performed. When there are both consensus and 200 status code, the tracking queue is updated, transaction history is saved, and replication is performed. In some embodiments, the consensus is recorded.

FIG. 5B illustrates another example architecture of a data broker 500B in accordance with some embodiments. The data broker 500B includes an API translator, a producer, a message broker, and a consumer. The API translator is configured to translate the received message, and sends the translated message to the producer. The producer passes the translated message to the message broker, which in turn passes the message to the consumer. The consumer is configured to distribute the message to a plurality of N blockchains and a document database. Responsive to receiving the message, the plurality of N blockchains and the document database performs an action associated with the message. Responsive to performing the action, the blockchains and the document database send confirmations to the consumer. Responsive to receiving the confirmations from the blockchains and the document database, the consumer passes the confirmation back to the producer, such that the producer can keep track of the performance of each of the blockchains and document database.

FIG. 5C illustrates another example architecture of a data broker 500C in accordance with some embodiments. Unlike data broker 500A, the data broker 500C does not include a producer, and the consumer passes the confirmations received from the blockchains and document database to the API translator, and the API translator keeps track of performance of each of the blockchains and document database.

Generally, processing times in blockchain are high. To achieve an answer in less than a second without relying on the blockchain, the data distribution system further includes an intermediate database (that is a mutable database) that simulates the functionality of the blockchain giving an instant response and sending the request in the background to the blockchain without waiting for a result.

In some embodiments, the intermediate database is a main database, and blockchain is a secondary database. Transactions are executed in the intermediate database, which generates a unique identifier for each transaction. The transactions are replicated in the secondary database, and the generated identifier is related to the identifier of the primary database. This allows to have the primary and secondary databases in sync and the processing is executed in the background. The multiple development environments, such as the blockchain, intermediate database, and MQ, are connected to each other. A configuration of environments is generated to indicate the relationship and connection parameters of each of them.

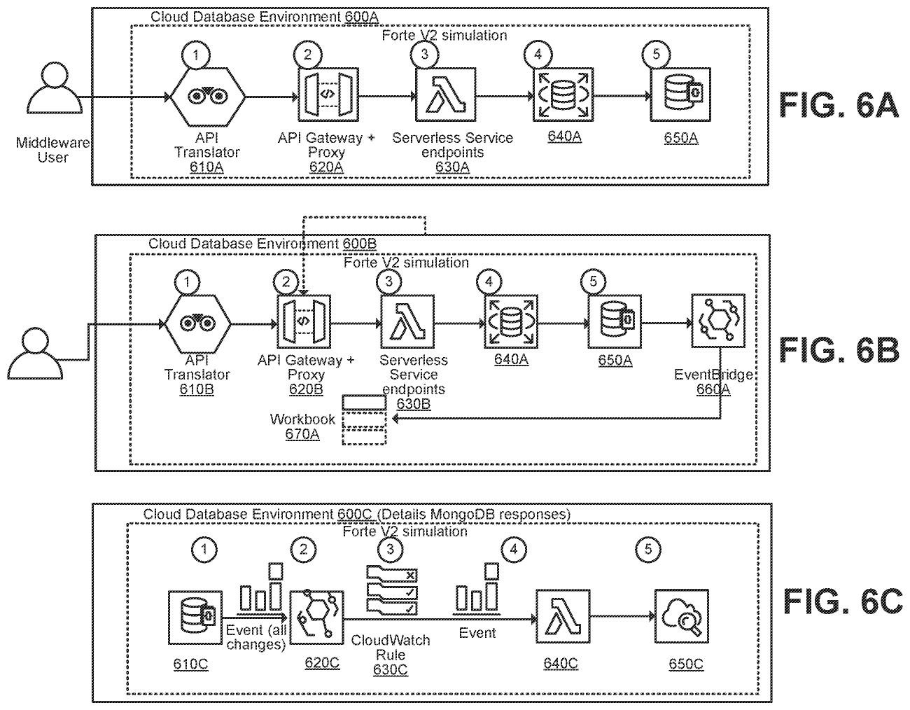

FIG. 6A illustrates an example architecture of a cloud database environment 600A in accordance with some embodiments. The cloud database environment 600A includes an API translator 610A, an API gateway and proxy 620A, a serverless compute service endpoint 630A (e.g., AWS® lambda endpoint), a relational database service 640A, and a document database 650A (e.g., MongoDB® database). The API Translator 610A serves as a middleware that helps in translating or transforming the request-response communication between different APIs. It can help in converting data formats, protocols, or even the structure of requests/responses to make different services interoperable. This is especially useful when integrating with diverse systems that may use different API standards or conventions. The API Gateway and Proxy 620A is an interface that manages and directs incoming API calls. It acts as a single entry-point for defined back-end APIs and microservices. It typically handles functionality such as routing requests, composition, and protocol translations. As a Proxy, it can also help with load balancing, security features (like authentication and authorization), rate limiting, and logging. The Serverless Compute Service Endpoint 630A (e.g., AWS Lambda endpoint) represents an interface where an event-driven, serverless computing platform receives and processes events. It allows running code for virtually any type of application or backend service, automatically managing the computing resources without managing servers. The Relational Database Service 640A (such as Amazon's RDS) provides capabilities for easily setting up, operating, and scaling a relational database in the cloud. It offers cost-efficient and resizable capacity while automating time-consuming administration tasks such as hardware provisioning, database setup, patching, and backups, freeing developers to focus on their applications. The Document Database 650A (e.g., MongoDB) is a NoSQL database that is designed to store, retrieve, and manage document-oriented information. It is used for large sets of distributed data, and it can store semi-structured data with flexible schemas.

FIG. 6B illustrates another example architecture of a cloud database environment 600B in accordance with some embodiments. The data distribution system 600B includes an API translator 610B, an API gateway and proxy 620B, a serverless compute service endpoint 630B (e.g., AWS® lambda endpoint), an in-memory database 640B, a document database 650B, an event bridge 660B, and a webhook 670B. The webhook 670A is configured to detect events. The API Translator 610B is a component that translates or transforms the request-response communication between different APIs, allowing them to interact seamlessly. It may translate data formats, protocols, or structures to ensure interoperability. The API Gateway and Proxy 620B is the single entry-point for managing and directing incoming API calls to various backend services. It handles tasks such as request routing, composition, and protocol translations. It also takes care of functionalities like rate limiting, security enforcement (authentication, authorization), and logging as a Proxy. The Serverless Compute Service Endpoint 630B (e.g., AWS® Lambda endpoint) represents an interface where an event-driven, serverless computing platform receives and processes events. It allows running code for virtually any type of application or backend service, automatically managing the computing resources without managing servers. The In-memory Database 640B stores data in memory (RAM) for faster access times, instead of on traditional disk drives. It provides high-speed data access, manipulation, and persistence. Examples of these include Redis or Memcached. The Document Database 650B is a type of non-relational (NoSQL) database that is designed to store, retrieve, and manage document-oriented information. It can manage semi-structured data and offer flexible, dynamic schemas. MongoDB® is an example of a document database. The Event Bridge 660B is a service that allows applications to communicate with each other using events. Events are used to signal a change in the state of an environment or application. The Event Bridge can ingest, filter, transform, and deliver events from various sources to different destinations. The Webhook 670B is a method used to provide real-time information to other applications. It is a way for an application to provide other applications with real-time information. It works by sending an HTTP request to a specified endpoint when a certain event occurs. This webhook is configured to detect specific events, which then triggers the sending of the information.

FIG. 6C illustrates another example architecture of a cloud database environment 600C in accordance with some embodiments. The data distribution system 600C includes a document database 610C, an event bridge 620C, a cloud watch rule manager 630C, a serverless compute service 640C, and a cloud monitor 650C. The Document Database 610C is a type of NoSQL database that stores data in a semi-structured manner. This type of database is optimized for workloads that require flexible, JSON-like documents which can vary in structure. Examples include MongoDB and CouchDB. The Event Bridge 620C serves as a serverless event bus that connects application components using data from other services. It takes care of event ingestion and delivery, security, authorization, and error-handling thus facilitating scalability. The Cloud Watch Rule Manager 630C enables to create, edit, and manage events rules that watch for changes in the cloud environment and triggers responses (or actions) based on preconfigured rules. The Serverless Compute Service 640C, allows to run code without provisioning or managing servers and the service handles everything required to run and scale the applications, including high availability. The Cloud Monitor 650C offers a reliable, scalable, and flexible monitoring solution without the need to set up, manage, and scale other monitoring systems and infrastructure. It provides data and actionable insights to monitor applications, understand and respond to system-wide performance changes, optimize resource utilization, and get a unified view of operational health.

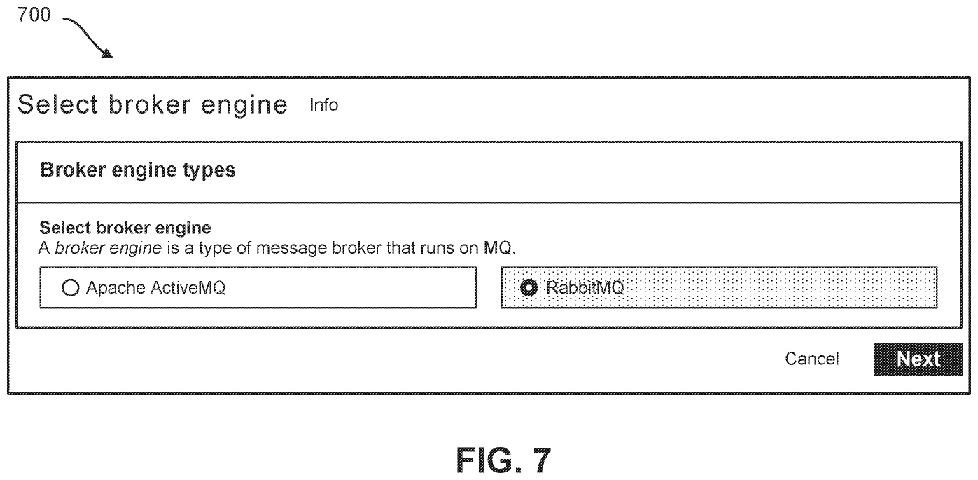

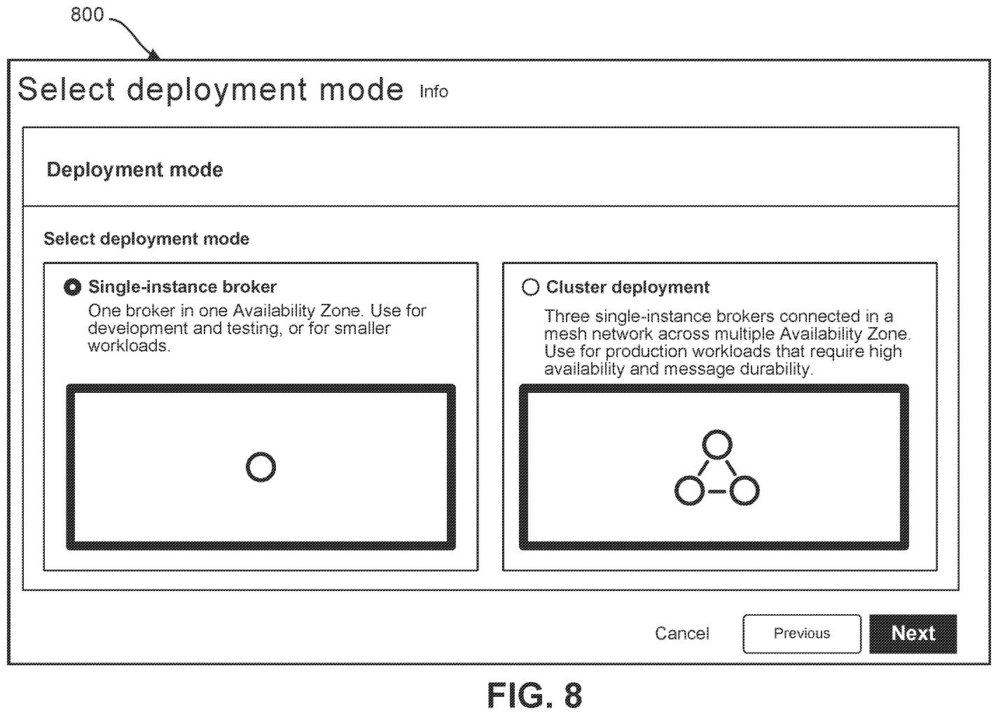

FIG. 7 illustrates an example graphical user interface 700 that allows users to create a message broker. FIG. 8 illustrates another example graphical user interface 800 that allows users to choose a single-instance broker mode or a cluster broker mode. In the single-instance broker mode, a single-instance broker includes one broker in one availability zone behind a network load balancer (NLB). The broker communicates with an application and with a block storage volume (e.g., Amazon® EBS storage volume). A cluster broker is used for high availability. It includes a logical grouping of multiple broker nodes behind an NLB, each shares users, queues, and a distributed state across multiple availability zones.

Users can enter the broker name. Generally, a personally identifiable information or other confidential or sensitive information should not be included in broker names Broker names may be accessible to other client services, including cloud monitor logs. Broker names are not intended to be used for private or sensitive data.

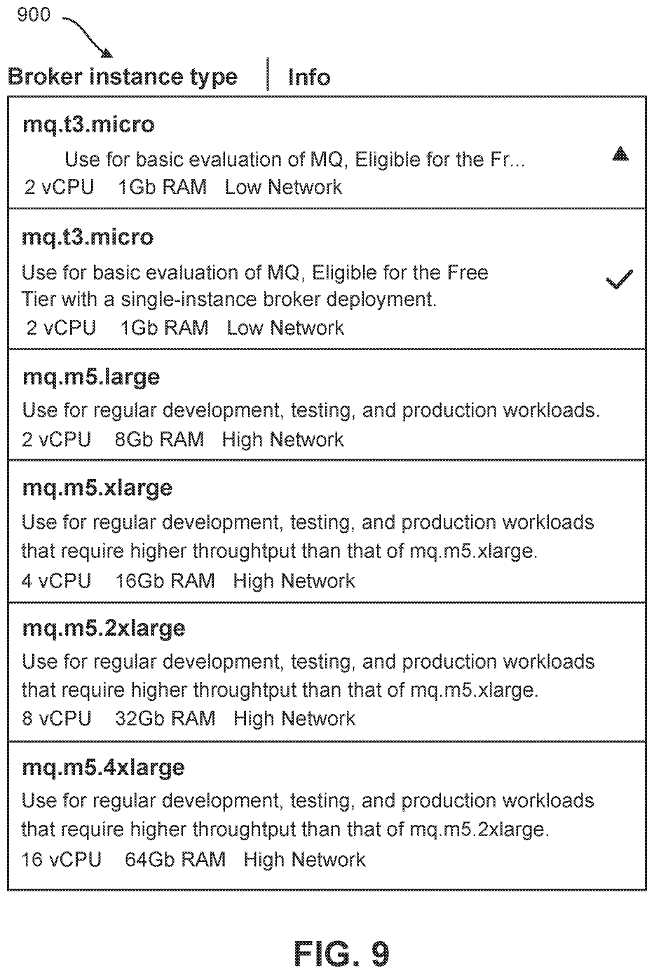

FIG. 9 illustrates an example graphical user interface 900 that allows users to choose a broker instance type. Additional settings section provides options to enable cloud monitor logs and configure network access for the user's broker. If the user creates a private message broker without public accessibility, the user often also needs to select a virtual private cloud (VPC) and configure a security group to access the broker.

In some embodiments, on a configuration setting page, in the message broker access section, the user can provide a username and a password. Certain restrictions may be applied to broker usernames and passwords. For example, a username may be required to contain only alphanumeric characters, dashes, periods, and underscores (- . _). This value must not contain any tilde (˜) characters. Amazon MQ prohibits using guest as a username. The password may be required to be at least a threshold number of characters long, contain at least a threshold number of unique characters, and not contain certain special characters.

After username and password are entered, a review and create page may be presented, and the user can review their selections and edit them as needed. Alternatively, the user can choose to create the broker. Creating a broker may take a few minutes. During the time the broker is being created, the system may display a creation in progress status. After the broker is created, the system may show a running status.

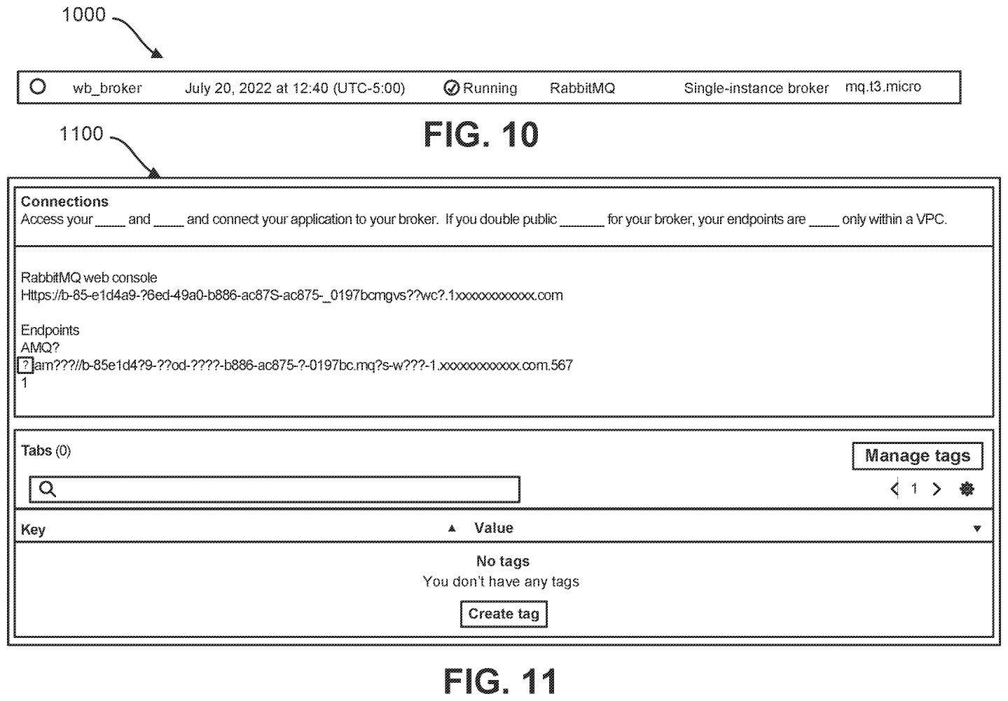

FIG. 10 illustrates an example user interface 1000 that shows a broker status as running.

FIG. 11 illustrates an example user interface 1100 that shows information associated with a particular broker. The user interface includes a connections section that shows the broker's web console URL and endpoints.

In some embodiments, a remote procedure call (RPC) service may be used to create a client class, which exposes a method named call that sends an RPC request and blocks until an answer is received. Example code for a client interface of an RPC service is shown below.

```
payload = {
  “data”: {
  },
  “config”:{
    “exchange”: “PLAN_P”,
    “url”: “/users/4a1279b1-b746-419f-b0d1-5b9664cf5b1d”,
    “method”: “GET”,
    “routing_key”: “get_user”,
  },
  “params” :{
    “per_page”: 100,
    “cursor”: 1
  },
  “headers”:{
    ‘Content-Type’: ‘application/json’,
    ‘token’: ‘fgnxhjkhjlhgreeayu6gtHDFGXhgjhdfzghgfVBvcbnBVnhb=’
  }
}
basic_message_sender = BasicPikaClient( )
payload = basic_message_sender
  .call(payload, payload[“config”][“exchange”],
  payload[“config”][“routing_key”])
```

In general, a client sends a request message and a server replies with a response message. In order to receive a response, the client needs to send a ‘callback” queue address with the request. Example suede code for a call queue is shown below.

```
  def call(self, json_request, exchange, routing_key):
    originator_code = json_request.get(“originator_code”)
    #Get the endpoint from the configuration and validate
    self.response = None
    self.corr_id = str(uuid.uuid4( ))
    start_time = time.time( )
    start_date = datetime.now( )
    self.channel.basic_publish(
      exchange=exchange,
      routing_key=routing_key,
      properties=pika.BasicProperties(
        reply_to=self.callback_queue,
        correlation_id=self.corr_id,
      ),
      body=json.dumps(json_request))
    exec_time = 0
    start_time = time.time( )
    while self.response is None and exec_time < 10:
      self.connection.process_data_events(0)
      end_time = time.time( )
      end_date = datetime.now( )
      exec_time = end_time − start_time
    if self.response is None:
      return {
        ‘statusCode’: 200,
        ‘routing_key’: routing_key,
        ‘body’: json.dumps({
          ‘transaction_id’: self.corr_id,
          ‘mensaje’: “the request is in process, retrieve the response
with the transaction_id and the routing key”
        })
      }
    # Close connections.
    self.channel.close( )
    self.connection.close( )
    payload = json.loads(self.response)
    return payload
```

In some embodiments, delivery_mode property is used to mark a message as persistent (e.g., with a value of 2) or transient (e.g., with any other value). In some embodiments, content_type property is used to describe the mime-type of the encoding. For example, for JSON encoding, it is advantageous to set this property to: application/json. In some embodiments, reply_to property is used to name a callback queue. In some embodiments, correlation_id is useful to correlate RPC responses with requests.

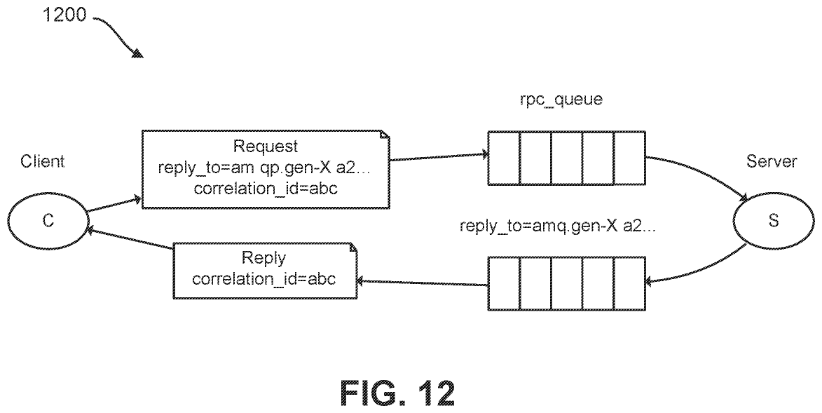

FIG. 12 illustrates an example process of remote procedure call (RPC) 1200 in accordance with some embodiments. In some embodiments, when a client starts up, it creates an anonymous exclusive callback queue. For an RPC request, the client sends a message with two properties: reply_to and correlation_id. Reply_to is set to the callback queue, correlation_id is set to a unique value for every request. The request is sent to an rpc_queue queue. The RPC worker is waiting for requests on that queue. When a request appears, the RPC worker does the job and sends a message with the result back to the client, using the queue from the reply_to field. The client waits for data on the callback queue. When a message appears, it checks the correlation_id property. If it matches the value from the request, the response to the application is returned.

Serverless compute service (e.g., AWS® Lambda) can connect to and consume message from the message broker. When a user connects a broker to a serverless compute service, an event source mapping is created. The event source mapping reads messages from a queue and invokes the function synchronously. The event source mapping reads messages from the message broker in batches and converts them into a payload (e.g., lambda payload) the form of a data object (e.g., a JSON object).

In some embodiments, a configuration file (e.g., a template YAML file) is used for the creation of the serverless compute services. The configuration file indicates the configuration of each one of the compute services. In a same serverless compute service, multiple events are indicated that will function as a consumer to the queue indicated in the “Queues” property.

In some embodiments, a primary consumer lambda is used to execute a transaction in a primary database. The primary consumer lambda includes a method defined as def store_DB_ID (ID, exchange, resource, action):

Input parameters include ID, exchange, resource, and action. ID is a primary ID to store in the identifiers collection. Exchange is related to exchange to store the ID. Resource indicates the module to which it belongs (e.g., users, nonfungibles, etc.). Action indicates the action to be executed.

An example YAML description for primary consumer in accordance with some embodiments is shown below.

```
#consumer primary
  lConsumeBrokerPrimary:
    Type: AWS::Serverless::Function
    Properties:
      FunctionName: !Sub “${EnvPrefix}−lConsumeBrokerPrimary”
      CodeUri: ./src/broker/consumer_user
      Timeout: 20
      Role: !GetAtt MongoBRWrite.Arn
      Events:
        #users
        MQEvent:
          Type: MQ
          Properties:
            Broker: !Sub “${arnBR}”
            Queues:
              - BR_USER_GET
            SourceAccessConfigurations:
              - Type: BASIC_AUTH
                URI: !Sub “${SecretsBR}”
            Enabled: true
            BatchSize: 10
            MaximumBatchingWindowInSeconds: 0
        MQEvent2:
          Type: MQ
          Properties:
            Broker: !Sub “${arnBR}”
            Queues:
              - BR_USER_POST
            SourceAccessConfigurations:
              - Type: BASIC_AUTH
                URI: !Sub “${SecretsBR}”
            Enabled: true
            BatchSize: 10
            MaximumBatchingWindowInSeconds: 0
        MQEvent3:
          Type: MQ
          Properties:
            Broker: !Sub “${arnBR}”
            Queues:
              - BR_USER_DELETE
            SourceAccessConfigurations:
              - Type: BASIC_AUTH
                URI: !Sub “${SecretsBR}”
            Enabled: true
            BatchSize: 10
            MaximumBatchingWindowInSeconds: 0
      MemorySize: 512
```

In some embodiments, a consumer replicator lambda is used to replicate transaction in a secondary database, obtaining the transaction from a message queue for further processing. An example YAML description for consumer replicator in accordance with some embodiments is shown below.

```
lConsumeBrokerReplicate:
  Type: AWS::Serverless::Function
  Properties:
    FunctionName: !Sub “${EnvPrefix}−lConsumeBrokerReplicate”
    CodeUri: ./src/broker/consumer_replicator
    Timeout: 20
    Role: !GetAtt MongoBRWrite.Arn
    Events:
      MQEvent:
        Type: MQ
        Properties:
          Broker: !Sub “${arnBR}”
          Queues:
            - BR_REPLICATE_FORTE
          SourceAccessConfigurations:
            - Type: BASIC_AUTH
              URI: !Sub “${SecretsBR}”
          Enabled: true
          BatchSize: 10
          MaximumBatchingWindowInSeconds: 0
      MQEvent2:
        Type: MQ
        Properties:
          Broker: !Sub “${arnBR}”
          Queues:
            - BR_REPLICATE_PLAN_P
          SourceAccessConfigurations:
            - Type: BASIC_AUTH
              URI: !Sub “${SecretsBR}”
          Enabled: true
          BatchSize: 10
          MaximumBatchingWindowInSeconds: 0
      #users
      MQEvent3:
        Type: MQ
        Properties:
          Broker: !Sub “${arnBR}”
          Queues:
            - BR_USER_PATCH_REPLICA
          SourceAccessConfigurations:
            - Type: BASIC_AUTH
              URI: !Sub “${SecretsBR}”
          Enabled: true
          BatchSize: 10
          MaximumBatchingWindowInSeconds: 0
      MQEvent4:
        Type: MQ
        Properties:
          Broker: !Sub “${arnBR}”
          Queues:
            - BR_USER_DELETE_REPLICA
          SourceAccessConfigurations:
            - Type: BASIC_AUTH
              URI: !Sub “${SecretsBR}”
          Enabled: true
          BatchSize: 10
          MaximumBatchingWindowInSeconds: 0
      MQEvent5:
        Type: MQ
        Properties:
          Broker: !Sub “${arnBR}”
          Queues:
            - BR_USER_POST_REPLICA
          SourceAccessConfigurations:
            - Type: BASIC_AUTH
              URI: !Sub “${SecretsBR}”
          Enabled: true
          BatchSize: 10
          MaximumBatchingWindowInSeconds: 0
```

In some embodiments, a notification lambda is used to get messages that require a transaction identifier to be recalled. An example YAML description for consumer notification in accordance with some embodiments is shown below.

```
lConsumeBrokerNotify:
  Type: AWS::Serverless::Function
  Properties:
    FunctionName: !Sub “${EnvPrefix}−lConsumeBrokerNotify”
    CodeUri: ./src/broker/consumer_notify_forte
    Timeout: 20
    Role: !GetAtt MongoBRWrite.Arn
    Events:
      MQEvent:
        Type: MQ
        Properties:
          Broker: !Sub “${arnBR}”
          Queues:
            - BR_NOTIFICATION_FORTE
          SourceAccessConfigurations:
            - Type: BASIC_AUTH
              URI: !Sub “${SecretsBR}”
          Enabled: true
          BatchSize: 10
          MaximumBatchingWindowInSeconds: 0
      MQEvent2:
        Type: MQ
        Properties:
          Broker: !Sub “${arnBR}”
          Queues:
            - BR_APP_NOTIFY
          SourceAccessConfigurations:
            - Type: BASIC_AUTH
              URI: !Sub “${SecretsBR}”
          Enabled: true
          BatchSize: 10
```

### Lazy Minting of Tokens

In some embodiments, an action is associated with a token, e.g., an NFT or a fungible token, on a blockchain. At a later stage of purchasing a token, a step called lazy minting is performed. Minting a token includes creating a unique token on the blockchain. Only after minting, the token becomes a digital collectible stored on the blockchain. When a data broker includes both an immutable database (e.g., blockchain) that is used to host token, and a mutable database that is used as a main system, a new lazy minting process is implemented. In the data broker, lazy minting may be used to modify the transaction tracker to generate or track consensus between multiple databases.

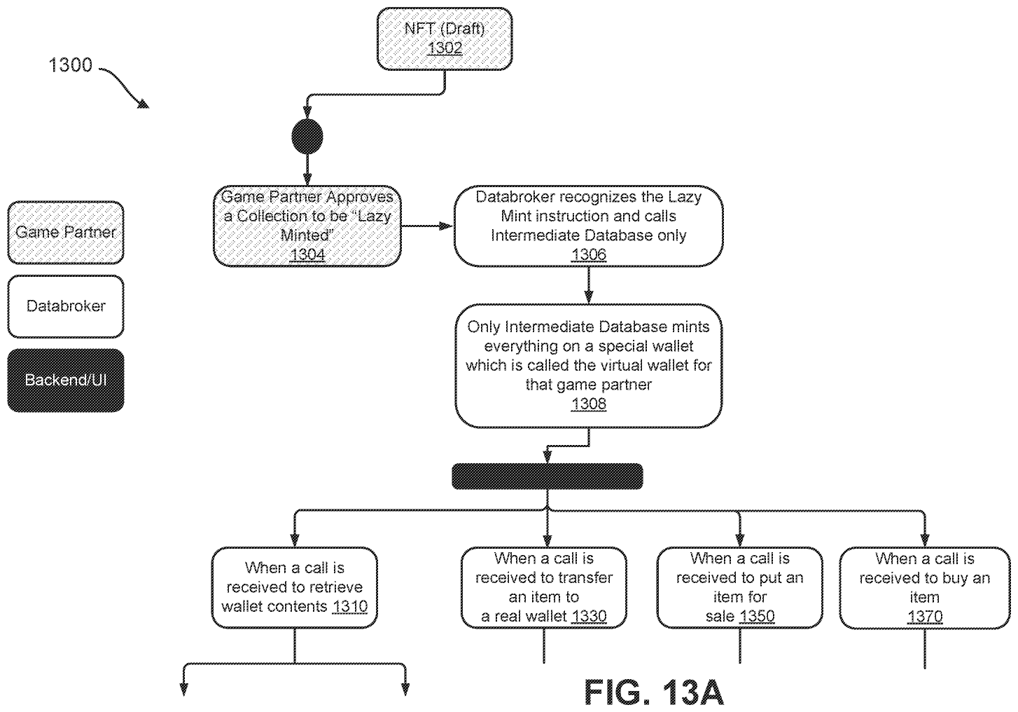

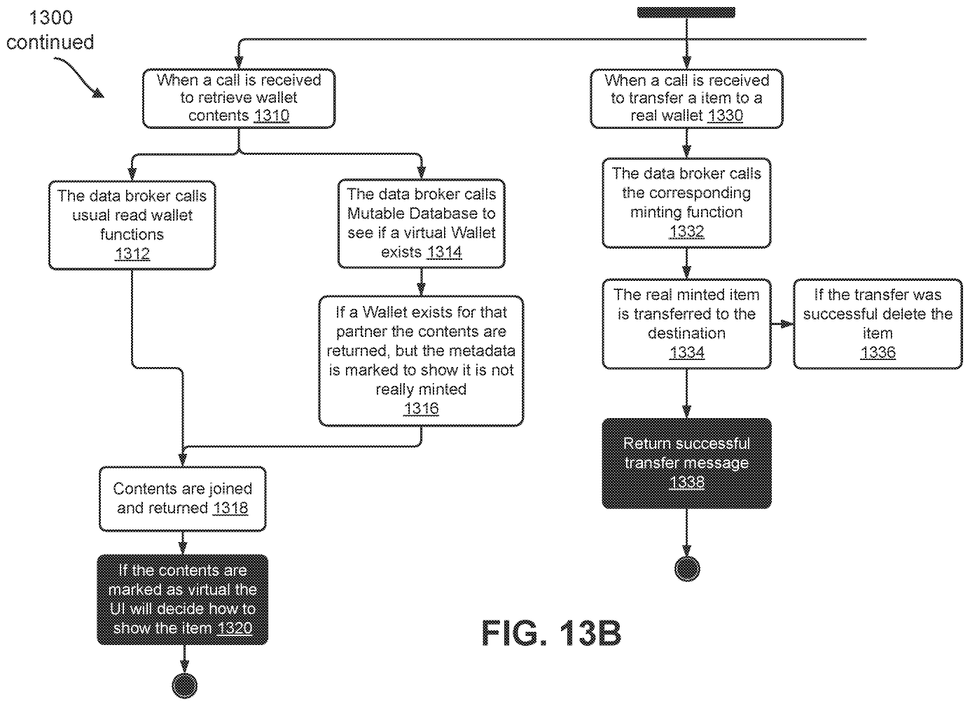

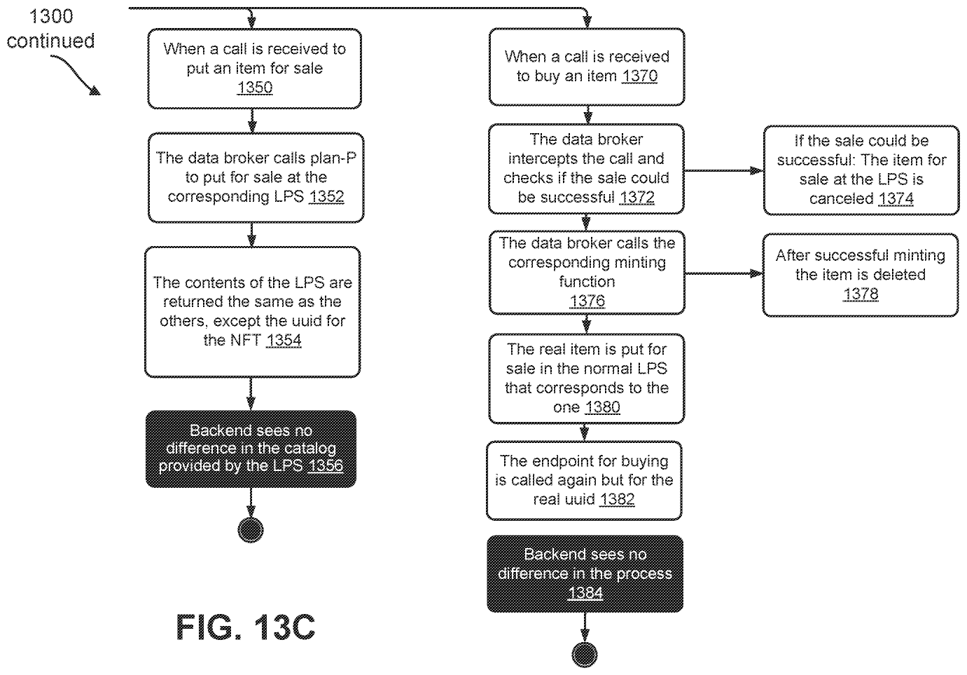

FIGS. 13A-13C illustrate an example process 1300 of lazy minting an NFT in a data distribution system with both immutable and mutable databases in accordance with one or more embodiments. As illustrated in FIG. 13A, after a game partner drafts 1302 an NFT and approves 1304 a collection of draft NFT to be lazy minted. In some embodiments, to set the status to pre-minted, all the status change petitions are sent. After the game partner approves 1304 the collection to be lazy minted, the data broker recognizes 1306 the lazy mint instruction and calls an immutable database only. The immutable database mint 1308 the collection of the NFT on a special wallet which is called a virtual wallet for that game partner. The immutable database may later receive 1310, 1330, 1350, 1370 a call associated with the virtual wallet. The call may include (but is not limited to) a call to retrieve 1310 content in a wallet, a call to transfer 1330 a particular item in a wallet to a real wallet, a call to put 1350 a particular item in a wallet for sale, and/or a call to buy 1370 a particular item in the virtual wallet.

Referring to FIG. 13B, when a call to retrieve 1310 contents in a wallet is received, the data distribution system calls 1312 a read function configured to read the contents in a real wallet from an immutable database. The system also calls 1314 the mutable database to see if there is a virtual wallet corresponding to the real wallet. If a virtual wallet exists, the contents are returned, but metadata is marked to show that it is not really minted 1316, contents from the real wallet of the immutable database and contents in the mutable database are joined and returned 1318. In some embodiments, the contents are presented 1320 in a user interface in a manner reflecting whether the content is marked as virtual or not really minted.

When a call to transfer 1330 a particular item to a real wallet is received, the system calls 1332 a corresponding minting function to mint the particular item. The real minted item is transferred 1334 to a particular destination. If the transfer is successful, the system deletes 1336 that item from the virtual wallets, and returns 1338 a successful transfer message.

Referring to FIG. 13C, when a call to put 1350 a particular item for sale, the system calls 1352 the mutable database to put for sale at log processing service (LPS). Contents of the LPS are returned 1354 same as others, except the user unique identifier (UUID) for the NFT associated with the particular item. The backend (e.g., blockchain) sees 1356 no difference in the catalog provided by the LPS.

When a call to buy 1370 a particular item is received, the system intercepts 1372 the call and checks if the sale could be successful. If the sale could be successful, the item at the LPS is cancelled 1374. The system calls 1376 a corresponding minting function. After successful minting the item, the item is deleted 1378 from the virtual wallet. The real item is put 1380 for sale in a normal LPS that corresponds to the virtual one. The endpoint for buying is called 1382 again but for the real UUID. Again, backend sees 1384 no difference in the process.

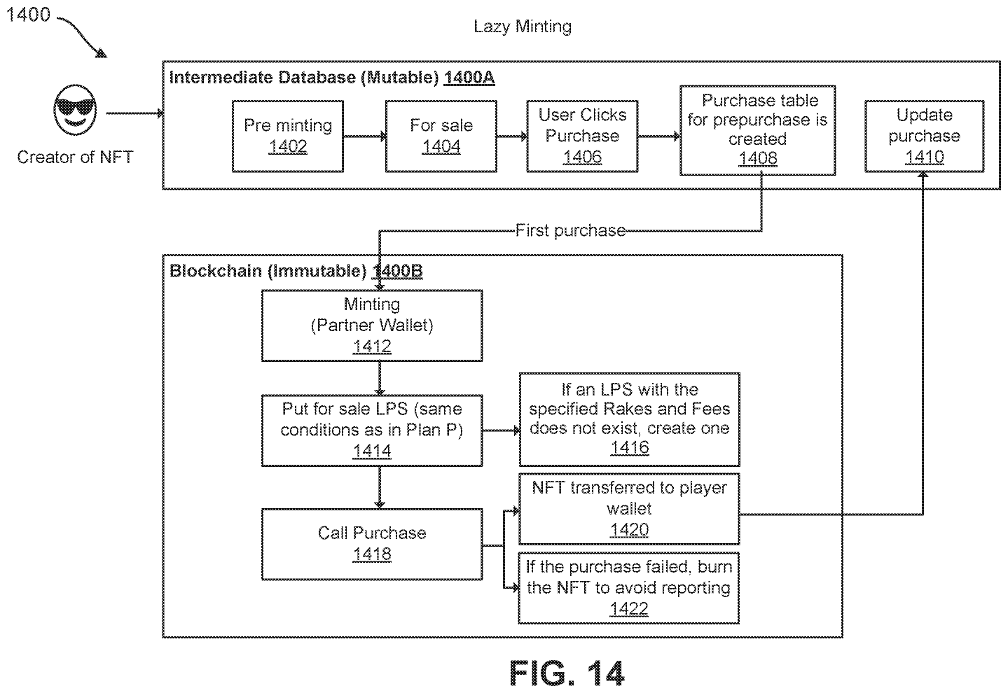

FIG. 14 illustrates another example process of lazy minting 1400 using a mutable database 1400A (which may be an intermediate database) and an immutable database 1400B (which may be a blockchain) in accordance with some embodiments. As illustrated in FIG. 14, mutable database 1400A pre-mints 1402 an NFT, and puts the pre-minted NFT for sale 1404. Responsive to receiving 1406 a user's indication (e.g., clicking the for sale NFT) of purchasing the NFT, mutable database 1400A creates 1408 a purchase table for pre-purchase. Responsive to creating the purchase table for pre-purchase, mutable database 1400A sends the purchase to the immutable database 1400B for minting. The immutable database 1400B mints 1412 the NFT, puts 1414 the NFT for sale at an LPS under same conditions as in the mutable database 1400A. If an LPS with the specified rakes and fees does not exist, the immutable database 1400B creates 1416 one. The immutable database 1400B calls 1418 a purchase. If the purchase succeeds, the NFT is transferred 1420 to a player's wallet, and the immutable database 1400B causes mutable database 1400A to update 1410 the purchase. If the purchase fails, the NFT is burned 1422 to avoid reporting.

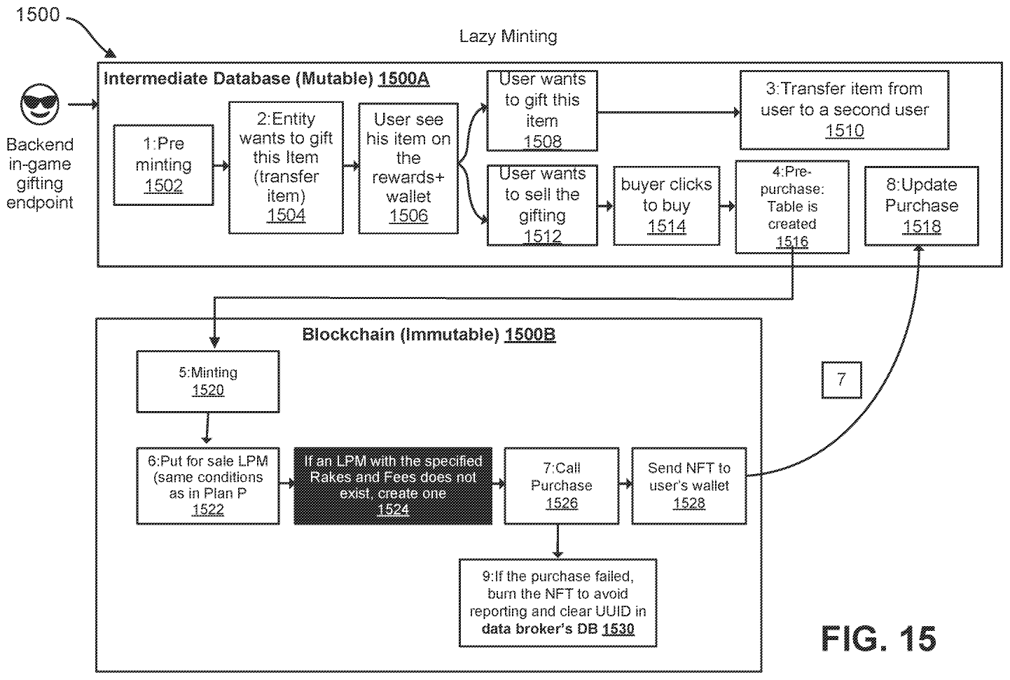

FIG. 15 illustrates another example process of lazy minting 1500 using a mutable database 1500A (which may be an intermediate database) and an immutable database 1500B (which may be a blockchain) in accordance with some embodiments. As illustrated in FIG. 15, mutable database 1500A pre-mints 1502 an NFT. Responsive to receiving 1504 an indication that an entity wants to gift the NFT to a user, causing the user to see 1506 the NFT on a reward wallet. The entity may be a gaming system. The user may be a user of the gaming system. The user can either keeps the NFT, regift the NFT to a second user, or sell the NFT to a second user. If the user wants to gift 1508 this item to a second user, the NFT is transferred 1510 from the user to the second user. If the user wants to sell 1512 the NFT, a buyer can indicate 1514 (e.g., click the NFT) their intent to purchase the NFT.

Responsive to receiving the buyer's indication, a purchase table for a pre-purchase is created 1516. Responsive to creating the purchase table for the pre-purchase, mutable database 1500A causes a blockchain to mint 1520 the NFT, and puts 1522 the NFT for sale at an LPM under same conditions as in mutable database 1500A. If an LPM with the specified rakes and fees does not exist, the immutable database 1500B creates 1524 one. The immutable database 1500B calls 1526 a purchase. If the purchase succeeds, the NFT is sent 1528 to the user's wallet, and the immutable database 1500B causes the mutable database 1500A to update 1518 the purchase. If the purchase fails, the immutable database 1500B burns 1530 the NFT to avoid reporting and clear UUID in data broker's database.

Note, the above described NFT transaction is a sales transaction or a gift transaction, embodiments described herein are not limited to sale of NFT. For example, in some embodiments, a transaction associated with an NFT may be a lease transaction, in kind transaction, or any other transactions the parties agreed upon. Further, the above-described principles are also applicable to fungible tokens, such as cryptocurrencies.

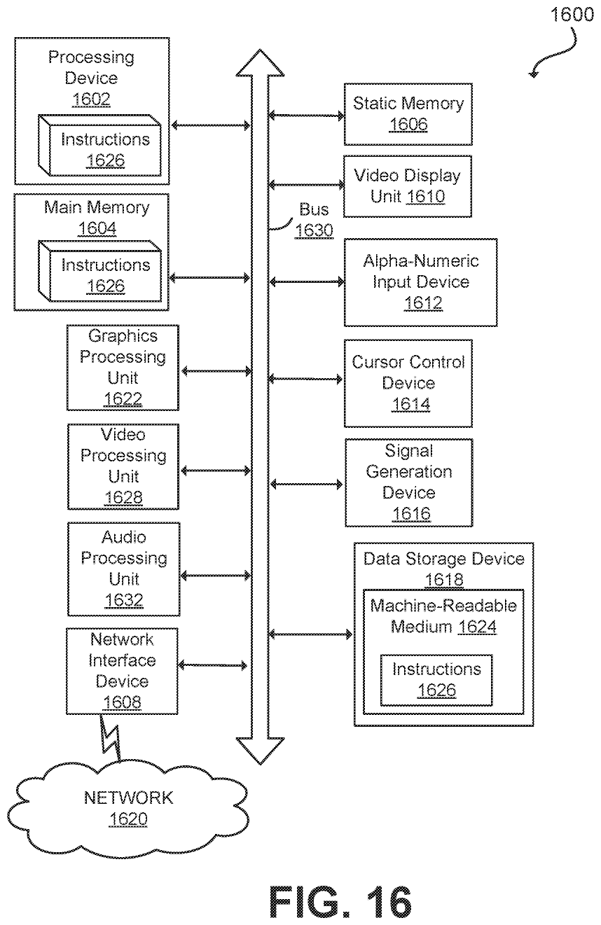

Many of the systems and subsystems described herein (such as, but not limited to, data brokers, data engines, mutable database systems, immutable database systems, user client devices, could database systems) include one or more computer systems. FIG. 16 illustrates an example machine of a computer system 1600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1600 includes a processing device 1602, a main memory 1604 (e.g., read-only memory (ROM), flash memory, dynamic random access memory (DRAM) such as synchronous DRAM (SDRAM), a static memory 1606 (e.g., flash memory, static random access memory (SRAM), etc.), and a data storage device 1618, which communicate with each other via a bus 1630.

Processing device 1602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1602 may also be one or more special-purpose processing devices such as an application specific integrated circuit (ASIC), a field programmable gate array (FPGA), a digital signal processor (DSP), network processor, or the like. The processing device 1602 may be configured to execute instructions 1626 for performing the operations and steps described herein.

The computer system 1600 may further include a network interface device 1608 to communicate over the network 1620. The computer system 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse), a graphics processing unit 1622, a signal generation device 1616 (e.g., a speaker), graphics processing unit 1622, video processing unit 1628, and audio processing unit 1632.

The data storage device 1618 may include a machine-readable storage medium 1624 (also known as a non-transitory computer-readable medium) on which is stored one or more sets of instructions 1626 or software embodying any one or more of the methodologies or functions described herein. The instructions 1626 may also reside, completely or at least partially, within the main memory 1604 and/or within the processing device 1602 during execution thereof by the computer system 1600, the main memory 1604 and the processing device 1602 also constituting machine-readable storage media.

In some implementations, the instructions 1626 include instructions to implement functionality corresponding to the present disclosure. While the machine-readable storage medium 1624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A system comprising:
a processing system comprising one or more processors; and
a memory system comprising one or more memories, the memory system coupled with processing system, the memory system comprising stored program code instructions that when executed causes the processing system to:
provide an endpoint configured to receive a message associated with database actions from client devices;
route the message to an action queue in response to receiving a message associated with a database action via the endpoint;
transmit the message from the action queue to a plurality of data engines corresponding to a plurality of data storage systems that store data, causing the plurality of data engines to perform the action based on the message, the plurality of data engines comprising a mutable data engine corresponding to a mutable data storage system and an immutable data engine corresponding to an immutable data storage system; and
track the action queue to determine an action performance speed of each of the plurality of data engines.

2. The system of claim 1, wherein the mutable data engine comprises at least one of an in-memory database, a relational database, a NoSQL database, or a timeseries database.

3. The system of claim 1, wherein the immutable data engine comprises a blockchain.

4. The system of claim 1, wherein the action is at least one of a POST action, a GET action, a DELETE action, or a PATCH action.

5. The system of claim 1, wherein the instructions to cause the immutable data engine further comprises stored instructions that when executed causes the processing system to:
compress a plurality of actions comprising the action into a single action;
cause the single action to be performed by the immutable data engine;
perform the single action by the immutable data engine in response to the immutable data engine being caused to generate a confirmation indicating that the single action has been carried out; and
receive a confirmation from the immutable data engine in response to an update being the action queue based on the confirmation.

6. The system of claim 5, wherein the plurality of data engines comprises a plurality of immutable data engines ranked based on their priorities, each of the plurality of immutable data engines comprised of stored instructions that when executed cause the processor system to:
select the data associated with the action recorded in a first immutable data engine in response to determining that the first immutable data engine having a first priority and a second immutable data engine having a second priority lower than the first priority contain inconsistent data associated with an action.

7. The system of claim 6, wherein priorities of the plurality of immutable data engines are determined based in part on trustworthiness scores of the plurality of immutable data engines.

8. The system of claim 6, wherein priorities of the plurality of immutable data engines are determined based in part on their processing speeds.

9. The system of claim 1, the immutable data engine is further caused to compress a plurality of actions into a single action and perform the single action to improve a transaction speed.

10. The system of claim 1, wherein tracking the action queue to determine an action performance speed of each of the plurality of data engines comprises tracking how far behind a specific data engine is from a most up-to-date data engine.

11. The system of claim 1, wherein the instructions to track the action queue to determine an action performance speed of each of the plurality of data engines further comprises stored instructions that when executed causes the processing system to track a last state identifier of each of the plurality of data engines, a last state identifier of a data engine increasing incrementally responsive to completion of an action.

12. The system of claim 1, wherein the message comprises a request to achieve a specific level of consensus among the plurality of data engines.

13. The system of claim 12, wherein the specific level of consensus includes a minimum number of data engines to return a same confirmation responsive to performing the action.

14. The system of claim 12, wherein the specific level of consensus includes a mixture of immutable and mutable data engines to return a same confirmation responsive to performing the action.

15. The system of claim 1, wherein the message is routed to the action queue among a plurality of action queues based in part of a set of rules.

16. The system of claim 1, wherein each of the plurality of data engines is associated with a trustworthiness score, and when the plurality of the data engines are not in consensus, a data engine associated with a highest trustworthiness score controls.

17. A method for minting tokens at data system having both a mutable database and an immutable database, the method comprising:
pre-minting a token by the mutable database, pre-minting the token comprising:
receiving, by the mutable database, a user indication, creating the token;
pre-minting the token at the mutable database;
placing the pre-minted token in a marketplace for transaction;
responsive to receiving a transaction request, generating a transaction table for a pre-transaction associated with the token; and
passing the transaction request to the immutable database;
minting the token by the immutable database in response to receiving the transaction request, the minting comprising:
minting the token at a partner wallet;
putting the token for transaction at a log processing service (LPS);
calling a transaction action associated with the transaction request;
responsive to the transaction being successful, transferring the token to a buyer's wallet; and
causing the mutable database to update a status of the transaction request as successful.

18. The method of claim 17, the method further comprising:
responsive to the transaction being failed, burning, by the immutable database, the token to avoid reporting.

19. The method of claim 17, the method further comprising:
determining, by the immutable database, whether an LPS with specified characters exists; and
creating, by the immutable database, an LPS in response to determining that no LPS with the specified characters exists.

20. The method of claim 17, wherein token comprises one or more transaction conditions, the mutable database puts the token for sale based on the one or more transaction conditions, and the immutable database puts the token for sale also based on the one or more transaction conditions.
